(19) United States
(12) Patent Application Publication
(10) Pub. No.: US 2007/0156461 A1
(43) Pub. Date: Jul. 5, 2007

(54) Method of offering insurance and providing insurance registration to trade show owners, management and exhibitors

(76) Inventors: Andrew J. Carson, Cleveland Heights, OH (US); Rick Rosalina, Cleveland, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/321,942

(22) Filed: Dec. 29, 2005

(51) Int. Cl. G06Q 40/00

(52) U.S. Cl. 705/4

(57) ABSTRACT

Disclosed is a method of providing insurance registration services to the owner or management of a trade show. The method includes receiving a list of exhibitors for the trade show from the owner or management and offering to the exhibitors insurance coverage for the trade show. The method may further include arranging for an insurance policy for the trade show. The method may further include approving the insurance status of exhibitors based on completion of an insurance registration process.

### TECHNICAL FIELD

The present invention relates generally to the field of insurance and trade show management and, more particularly, to a method of and system for offering insurance and providing insurance registration to trade show owners, management and exhibitors.

### BACKGROUND

Trade shows and similar events are typically owned and/or managed by a company that invites exhibitors to be present at the trade show to demonstrate goods and/or services offered by the exhibitors. Various models for trade shows are known, but typically involve providing a booth for each exhibitor from which the exhibitor demonstrates and/or sells goods and/or services to attendees of the trade show. A trade show is any event where exhibitors are invited to be present. Exemplary trade shows include conventions, arts and crafts sales, expositions, sporting events, and so forth.

Many trade shows require that each exhibitor have liability insurance in addition to any general liability insurance that the trade show owner and/or management carry. Some exhibitors may have existing insurance that covers their involvement at trade shows, while others do not. If the exhibitor does not have insurance, the exhibitor must seek out insurance, which may be relatively expensive and time consuming to acquire.

In addition, the owner and/or management of the trade show must establish insurance requirements for the exhibitors and confirm that each exhibitors has satisfied those insurance requirements. As a result, the owner and/or management can spend a considerable amount of time addressing insurance issues. For owners and/or management without sufficient knowledge of the insurance industry, without sufficient resources to verify that each exhibitor has the proper insurance or without the ability to provide insurance for each exhibitor, potentially problematic gaps in the insurance coverage for a trade show could arise.

### SUMMARY OF THE INVENTION

In view of the aforementioned shortcomings associated with existing trade show insurance practices, there is a need in the art for a method of and system for offering insurance and providing insurance registration to trade show owners, management and exhibitors.

According to an aspect of the invention, a method of providing insurance registration services to the owner or management of a trade show includes receiving a list of exhibitors for the trade show from the owner or management; and offering to the exhibitors insurance coverage for the trade show.

According to another aspect, the method further includes arranging for an insurance policy for the trade show.

According to another aspect, the arranging for the insurance policy includes contracting with an insurance agent or insurance provider to issue the insurance policy.

According to another aspect, the method further includes paying the owner or management for the list of exhibitors.

According to another aspect, the payment is based on the number of exhibitors.

According to another aspect, the method further includes receiving a request for insurance from at least one of the exhibitors.

According to another aspect, the method further includes adding the exhibitor that requested insurance to an insurance policy for the trade show.

According to another aspect, the request for insurance is received via the Internet by interaction of the exhibitor with a webpage.

According to another aspect, the method further includes approving an insurance status of the exhibitor for participation in the trade show.

According to another aspect, the method further includes offering to receive proof of insurance from the exhibitors.

According to another aspect, the method further includes approving an exhibitor for participation in the trade show upon receipt of satisfactory proof of insurance.

According to another aspect, the method further includes, for each exhibitor from which no request for insurance or proof of insurance is received by a predetermined deadline, adding the exhibitor to an insurance policy.

According to another aspect, the insurance policy names each exhibitor as an insured party.

According to another aspect, the method further includes charging a fee to exhibitors that at least one of request insurance or were added to the insurance policy.

According to yet another aspect of the invention, a method of providing insurance registration services to the owner or management of a trade show at which exhibitors are scheduled to participate includes arranging for an insurance policy for the trade show; and approving each exhibitor for participation in the trade show following receipt of one of a request for insurance or satisfactory proof of insurance from the exhibitor.

According to another aspect, the insurance policy names all exhibitors as insureds.

According to another aspect, the method further includes upon receipt of a request for insurance, adding the corresponding exhibitor to the insurance policy.

According to another aspect, the request for insurance is received via the Internet by interaction of the exhibitor with a webpage.

According to another aspect, the method further includes, for each exhibitor from which no request for insurance or proof of insurance is received by a predetermined deadline, adding the exhibitor to the insurance policy.

According to another aspect, the method further includes invoicing each exhibitor added to the insurance policy.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a flow chart depicting an exemplary method of offering insurance and providing insurance registration to trade show owners, management and exhibitors in accordance with the present invention;

FIG. 2 is a time line depicting an exemplary series of events relating to the method of FIG. 1; and

FIG. 3 is a schematic diagram of a system for offering insurance and providing insurance registration to trade show owners, management and exhibitors in accordance with the present invention.

### DESCRIPTION

The present invention will now be described with reference to the drawings, wherein like reference numerals are used to refer to like elements throughout. To illustrate an embodiment(s) of the present invention in a clear and concise manner, the drawings may not necessarily be to scale and certain features may be shown in somewhat schematic form.

Aspects of the invention relate to offering insurance and providing insurance registration for persons and entities involved with trade shows. As used herein, the term trade show is broadly defined and includes any event for which there is an owner and/or management that invites exhibitors to demonstrate goods and/or services, sell goods and/or services, make informative and/or entertaining presentations, and so forth. As such, trade shows include, but are not limited to, conventions, arts and crafts sales, themed or unthemed expositions, sporting events, and so forth. The owner of a trade show also may manage the show (e.g., hire staff, coordinate involvement of exhibitors, register exhibitors at the beginning of the trade show, etc.) or may contract with another party to undertake all or some of the management responsibilities of the trade show. While the invention is described in the exemplary context of a trade show, the invention has applicability to any situation where plural parties need insurance for a specific event and/or length of time, and/or there is a need to manage insurance related aspects of the relationship among the parties. In addition, any of the parties may be referred to by other names. For instance, the exhibitors may be referred to as vendors.

Aspects of the invention involve offering insurance and providing insurance registration services to parties involved with the trade show including the owner, the management (if different than the owner) and the exhibitors. In the exemplary embodiment described herein, the offering of insurance and insurance registration is carried out by another party, referred to herein as an intermediary. It will be appreciated that the tasks described as being carried out by the intermediary can be carried out by the owner, the management or distributed among multiple parties, but still fall within the scope of the present invention as defined by the claims appended hereto. Therefore, in some instances, the owner and/or the management can be the intermediary.

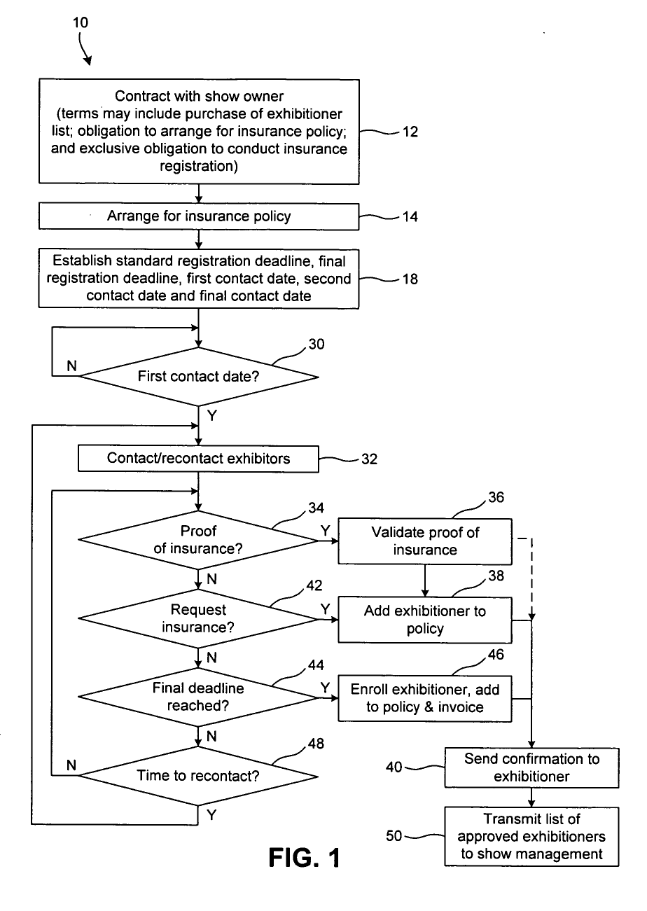

Referring to FIG. 1, shown is a flow chart depicting an exemplary method 10 of offering insurance and providing insurance registration services to trade show owners, management and exhibitors. The exemplary method 10 illustrates steps carried out by the intermediary. Complementary steps to be carried out by the trade show owner, the trade show management, the exhibitors and an insurance agent, insurance broker or insurance provider will be apparent to one of ordinary skill in the art. As will further be understood by one of ordinary skill in the art, the method 10 depicted in FIG. 1 can be implemented, at least in part, in a computing device, such as a host computing device that communicates with client computing devices via a network, such as the Internet.

Although the description here refers to a single trade show, it will be understood that the process can be applied to plural trade shows.

Although the method 10 illustrated in FIG. 1 shows a specific order of execution, it is understood that the order of execution may differ from that depicted. For example, the order of execution of two or more blocks may be changed relative to the order shown. Also, two or more blocks shown in succession may be executed concurrently or with partial concurrence. In addition, certain blocks may be omitted and/or other blocks may be added. It is understood that all such variations are within the scope of the present invention.

The method 10 can begin in block 12 where the intermediary enters into an agreement (e.g., a contract) with the trade show owner and/or management. The agreement can specify that the trade show owner and/or management will supply a list of the exhibitors or potential exhibitors that will have booths at the trade show to the intermediary. The list can include exhibitor contact information, including addresses, phone numbers, facsimile numbers, electronic mail addresses and so forth. In one embodiment, the intermediary agrees to pay a certain amount of money for the list. For example, the compensation for the list may be specified as a certain dollar amount per exhibitor.

The agreement can further specify that the intermediary will furnish a general liability insurance policy for losses and/or injuries resulting from the trade show. In one embodiment, all of the exhibitors for the trade show are named as insureds under the policy. Additional insureds may include the trade show owner and/or management, the venue and/or the intermediary. In most cases, the trade show owner and/or management, the venue and/or the intermediary will have their own liability insurance policy for events stemming from the trade show that is separate from the insurance policy identified in the contract of block 12. The trade show owner and/or management may agree to pay all or part of the premiums for the insurance policy, but it is contemplated that the cost of the policy will be paid by the intermediary. The specific coverage provided for in the policy can be specified in the contract, but is generally not important to the execution of the method 10 and will not be described in detail.

The agreement can further specify that the intermediary has the exclusive right to conduct insurance registration for the exhibitors of the trade show. In one embodiment, the contract can recite that the intermediary is to serve as the exclusive insurance registration provider for the trade show owner and/or management for plural trade shows, which may be determined by a specified number of trade shows, a specified series of trade shows, a specified duration (e.g., two years), etc. As will be described in greater detail, insurance registration can include confirming that each exhibitor has adequate insurance coverage and offering insurance to those exhibitors who do not have adequate insurance. Accordingly, the agreement can specify that the intermediary has the exclusive right to advertise and/or offer insurance for the trade show under the sponsorship or approval of the trade show owner and/or management. Other provisions of the agreement will be apparent to those familiar with drafting agreements between various parties.

It is typical that each exhibitor will have a contract with the trade show owner and/or management that sets forth the terms of their relationship. To facilitate the insurance registration process, the contract between each exhibitor and the trade show owner and/or management may specify that the exhibitor must have a certain type and/or minimum amount of insurance. The contract may further specify that the trade show owner and/or management, the venue and/or the intermediary are to be named in the exhibitor's insurance policy as additional insureds, or pay a fee. The contract may specify that proof of such insurance be provided to the intermediary, who may be specifically identified by name, by a certain date. The contract of block 12 between the trade show owner and/or management and the intermediary may specify that these terms will be present in the contracts between the trade show owner and/or management and the exhibitors.

Next, in block 14, the intermediary can arrange for an insurance policy from an insurance provider for the trade show that names at least the exhibitors as the insured(s) and that satisfies the agreed to level of coverage for the trade show. The policy will reserve the right to add individual exhibitors to the policy as additional insureds and, as indicated, may include the trade show owner and/or management, venue and/or the intermediary as additional insureds. The actual arranging for and/or purchase of the policy may involve an agent or broker working on behalf of the intermediary or the insurance provider.

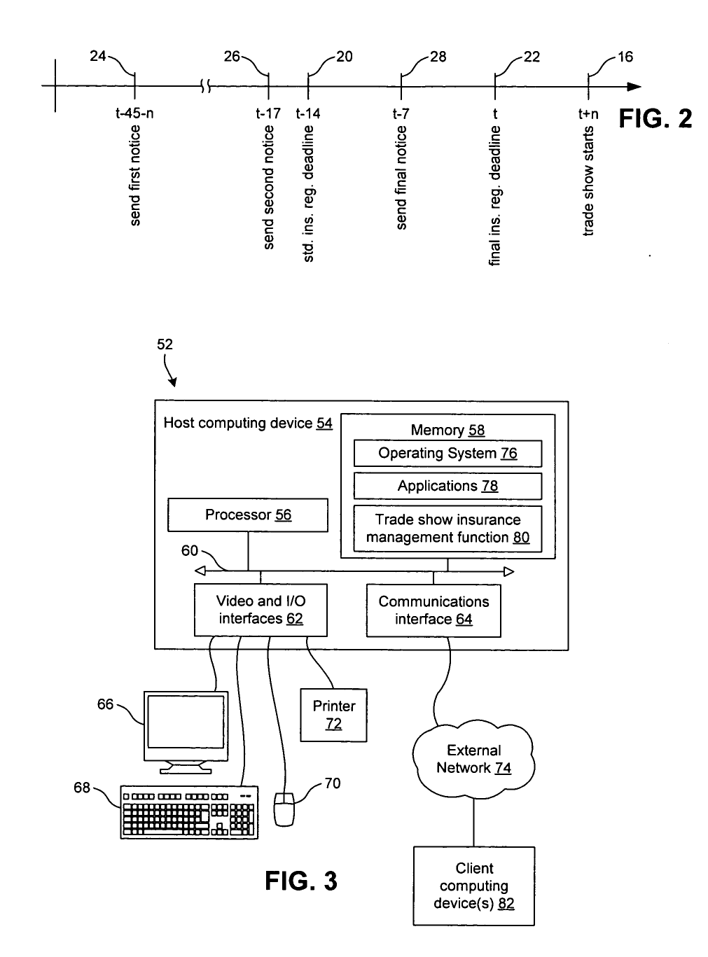

With additional reference to FIG. 2, a time line of events relating to the insurance registration process is shown. At a certain commencement date 16, the trade show will begin. The commencement date 16 of the trade show may be marked by the general registration process for the trade show when exhibitors begin to arrive at the trade show site and may be prior to the date and/or time when attendees to the trade show are scheduled to arrive.

In block 18, the intermediary establishes a standard insurance registration deadline 20 for the exhibitors and a final insurance registration deadline 22 for the exhibitors. The standard insurance registration deadline 20 is a date by which each exhibitor must either offer proof of insurance to the intermediary or request insurance for the trade show from the intermediary. As will become more apparent below, the standard insurance registration deadline 20 is an arbitrary date used to inform the exhibitors of when they must complete the insurance registration process. The standard insurance registration deadline 20 is given to the exhibitors as an encouragement to take action by that date. The final insurance registration deadline 22 is a date on which the intermediary will automatically enroll exhibitors who have not either provided satisfactory proof of insurance or requested insurance from the intermediary. Enrolling exhibitioners may include adding exhibitors to the insurance policy as described below in greater detail.

In the illustrated embodiment, the final insurance registration deadline 22 is further identified by the notation t, which may be a predetermined number of days (e.g., n days) before the commencement date 16. Accordingly, the commencement date is further identified by the notation t+n. Depending on the type of trade show and preferences of the intermediary, trade show owner and/or management, the final insurance registration deadline 22 may be about two to about thirty days before the commencement date 16, although other durations are contemplated.

In the illustrated embodiment, the standard insurance registration deadline 20 is fourteen days prior to the final insurance registration deadline 22. Hence, the standard insurance registration deadline 20 is further identified by the notation t-14 representing fourteen days (e.g., two weeks) before the final insurance registration deadline 22. Depending on the type of trade show and preferences of the intermediary, trade show owner and/or management, the standard insurance registration deadline 20 can be more than or less than fourteen days before the final insurance registration deadline 22.

In block 18, the intermediary also establishes a first contact date 24, a second contact date 26 and a final contact date 28. As will be described in greater detail below, the first contact date 24 is a date on which the intermediary will transmit information about the insurance registration process to the exhibitors. The second contact date 26 is a date on which the intermediary will again transmit information about the insurance registration process to the exhibitors. The final contact date 28 is a date on which the intermediary will again transmit information about the insurance registration process to the exhibitors. The information transmitted on the final contact date 28 preferably includes a warning that the exhibitor has until the final insurance registration deadline 22 (e.g., about a week in the illustrated example) to complete the insurance registration process or be automatically enrolled. If desired, additional contact dates can be added to the method 10 or one or more of the contact dates can be removed from the method.

In the illustrated embodiment, the first contact date 24 is forty-five days prior to the commencement date 16 of the trade show. Hence, the first contact date 24 is further identified by the notation t-45-n representing forty-five days (e.g., about one and a half months) before the commencement date 16. Depending on the type of trade show and preferences of the intermediary, trade show owner and/or management, the first contact date 24 can be more than or less than forty-five days before the commencement date 16.

In the illustrated embodiment, the second contact date 26 is three days prior to the standard insurance registration deadline 20. Hence, the second contact date 26 is further identified by the notation t-17 representing seventeen days before the final insurance registration deadline 22. Depending on the type of trade show and preferences of the intermediary, trade show owner and/or management, the second contact date 26 can be more than or less than three days before the standard insurance registration deadline 20.

In the illustrated embodiment, the final contact date 28 is seven days (e.g., one week) before the final insurance registration deadline 22. Hence, the final contact date 28 is further identified by the notation t-7, representing seven days before the final registration deadline 22. Depending on the type of trade show and preferences of the intermediary, trade show owner and/or management, the final contact date 28 can be more than or less than seven days before the final insurance registration deadline 22.

With continued reference to FIGS. 1 and 2, the method 10 can proceed to block 30 where it is determined whether the first contact date 24 has been reached. If the first contact date 24 has not been reached (a negative determination in block 30), the method 10 can wait until that date. Upon a positive determination in block 20, the method 10 can proceed to block 32.

In block 32, the exhibitors are contacted by the intermediary. In one embodiment, the intermediary transmits a notice to the exhibitor by one or more techniques, including, for example, electronic mail, facsimile (“fax”), regular mail (e.g., via the U.S. Postal Service), certified mail, independent courier (e.g., Federal Express or United Parcel Service) or orally by telephone.

The notice can include information about the insurance registration process that is relevant to the exhibitors. If transmitted by electronic mail, the electronic mail can include links to an Internet website of the intermediary through which the exhibitors can get information, access forms, view or download example documentation, submit documents and/or request insurance. For example, the electronic mail can be a hypertext mark-up language (HTML) electronic mail to support such functionality. Attached to the notice or included in the notice, regardless of the format, can be a sample proof of insurance certificate depicting the type of evidence that may be required to opt out of obtaining insurance through the intermediary. Also attached or included can be an insurance requirement form showing the insurance coverage that the exhibitor will need. In addition, attached or included can be a form that the exhibitor can use to request insurance through the intermediary, such as by printing the form, completing the form, and faxing or sending the form to the intermediary. In another embodiment, the notice attachments and/or forms can be provided to the exhibitors from the trade show owner and/or management, such as by inclusion in a manual distributed to the exhibitors by the trade show owner and/or management.

The information contained in the notice can include reference to the exhibitor's contract with the trade show owner and/or management; a description of the insurance that the trade show owner and/or management requires of the each exhibitor; a description of the relationship of the trade show owner and/or management with the intermediary; any parties to be listed as additional insureds; relevant dates and deadlines; an explanation of the insurance registration process; instructions concerning the submission of proof of insurance if the exhibitor already has or would like to seek out insurance from another party; instructions, cost and/or details relating to an option for the exhibitor to request insurance through the intermediary; and contact information of the intermediary. The notice can contain any other relevant information.

Other relevant information may include a description of the automatic enrollment process in the event that the exhibitor does not contact the intermediary by the final insurance registration deadline 22 as described below in greater detail. If present in the first and/or second notices, the description of the automatic enrollment process, however, may refer to the standard insurance registration deadline 20 as an incentive for the exhibitor to act quickly, even though automatic enrollment may not take place until the final insurance registration deadline 22. In one embodiment, in a first iteration of the method 10 (e.g., on the first contact date 24), the notice will not include information related to the automatic enrollment process or will include limited information related to the automatic enrollment process.

In block 34, it is determined whether any exhibitors have submitted proof of insurance. Any exhibitor that has insurance coverage for the trade show may submit proof of insurance in the form of a certificate from the exhibitor's insurance agent or provider. An insurance certificate can be submitted electronically to the intermediary (e.g., by electronic mail, file transfer, etc.), by mail or courier, by facsimile or any other appropriate delivery method. By submitting proof of insurance in block 34, the exhibitor is considered to have opted out of insurance offered by the intermediary. Accordingly, in block 34, if an insurance certificate is received from an exhibitor, the process can proceed to block 36. In block 36, the intermediary may validate the insurance certificate by reviewing the certificate and/or by contacting the exhibitor's insurance agent or provider. If the insurance certificate is not valid or clarification is needed, the intermediary can contact the exhibitor for a new or clarified insurance certificate.

Once a satisfactory insurance certificate is received, the method 10 can proceed to block 38, where the exhibitor is added to the insurance policy purchased in block 14. Adding the exhibitor to the insurance policy even if the exhibitor can show proof of insurance coverage (blocks 34 and 36) provides a safeguard as to the insurance coverage for the exhibitor. In another embodiment (represented by the dashed line in FIG. 1), the exhibitor is not added to the policy by skipping block 38 and proceeding directly to block 40, which will be described in greater detail below.

If a negative determination is made in block 34, the method 10 can proceed to block 42. In block 42 a determination is made as to whether the exhibitor has decided to request insurance through the intermediary. Requesting insurance for the trade show through the intermediary can include submitting a request form that includes information about the exhibitor, such as company name, booth number for the trade show assigned by the trade show management, address, telephone and fax numbers, electronic mail address, etc. The request can be submitted electronically (e.g., via electronic mail, file transfer or completing a form on an Internet website of the intermediary), by facsimile, by mail or courier, or any other appropriate delivery method. In one embodiment, the exhibitor may be asked to submit a payment in connection with the request for insurance. Payment for the insurance through the intermediary can be made to the intermediary in the form of a credit (or debit) card purchase, cash, wire transfer or electronic payment, check or the like. In a preferred embodiment, to obtain insurance through the intermediary, the exhibitor can complete a form on a secure Internet website of the intermediary to submit any appropriate information and credit (or debit) card payment information. For many exhibitors, requesting insurance through the intermediary using the preferred embodiment over the Internet should take about five minutes or less.

The cost of insurance obtained through the intermediary can vary based on the nature of the trade show, the insurance history of the trade show owner and/or management, the insurance history of the exhibitor and any other appropriate factor. For many trade shows, it is contemplated that multiple exhibitors will request insurance through the intermediary for addition to the policy purchased in block 14. On an exhibitor by exhibitor basis, the cost of the insurance policy purchased in block 14 may result in a cost reduction compared to each exhibitor obtaining insurance on their own. Cost savings can be passed to the exhibitors as an incentive to request insurance through the intermediary. It is contemplated that by obtaining insurance of this nature through the intermediary, the cost to the exhibitor may be about half of the amount that an insurance agent or provider would charge to an exhibitor seeking similar insurance on their own.

If the exhibitor requests insurance in block 42, the method 10 can proceed to block 38 where the intermediary adds the exhibitor to the policy purchased in block 14 as an additional insured. Thereafter, the method can proceed to block 40, which will be described in greater detail below.

If a negative determination is made in block 42, the method 10 can proceed to block 44 where a determination is made as to whether the final insurance registration deadline 22 (FIG. 2) has been reached. If the final insurance registration deadline 26 has been reached, the method can proceed to block 46.

In block 46, each exhibitor that did not submit proof of insurance (block 34) or request insurance (block 42) can be enrolled in the insurance registration program. The enrollment in block 46 can be automatic (e.g., without action by the exhibitor). Enrollment in the insurance registration program can include adding the exhibitor to the insurance policy purchased in block 14 as an additional insured. In addition, the exhibitor can be invoiced for the cost of being added to the policy. The invoiced amount can be the same as that charged to exhibitors who requested insurance in block 42 or a higher amount. If higher, the higher amount can represent a surcharge for not responding earlier. In addition, the higher amount can be used to cover the risk and expense involved in collecting from those automatically enrolled. In one embodiment, exhibitors cancelling from the trade show before the final insurance registration deadline 22 is reached will not be enrolled in block 46. Once enrollment in the insurance registration program is made in block 46, the method 10 can proceed to block 40, which will be described in greater detail below.

If a negative determination is made in block 44, the method 10 can proceed to block 48 where a determination is made as to whether the second contact date 26 (FIG. 2), final contact date 28 (FIG. 2), or any other appropriate contact date has arrived. If a negative determination is made in block 48, the method 10 can return to block 34. Upon a positive determination in block 48, the method can return to block 32. Similar to the first iteration of the method 10, in block 32 the exhibitors who have not yet supplied proof of insurance (block 34) or requested insurance (block 42) can be recontacted. For instance, if the second contact date 26 has arrived, a second notice can be transmitted to the appropriate exhibitors. The second notice can be transmitted by a different method than the transmission of the first notice, by the method with which the first notice was transmitted or by multiple methods. The second notice can contain the same information as the first notice, additional information (e.g., explaining the automatic enrollment process if not previously explained) and/or with a reminder of the urgency of taking action to participate in the insurance registration program.

If, in block 48, the final contact date 28 has arrived, a final notice can be transmitted to those exhibitors who have not yet submitted satisfactory proof of insurance or requested insurance through the intermediary. The final notice can be transmitted by a different method than the transmission of the first and/or second notices, by the method with which the first and or second notices were transmitted or by multiple methods. The final notice can contain the same information as the first and/or second notice, additional information (e.g., explaining the automatic enrollment process if not previously explained) and/or with an indication that the deadline for insurance registration has passed. For example, the final notice can explain that the exhibitor has an additional period of time (e.g., a number of days equaling the number of days until the final insurance registration deadline 22) to submit proof of insurance or request insurance through the intermediary, or automatically be enrolled as set forth in block 46.

As indicated, following blocks 38 and 46, the method 10 can proceed to block 40. In block 40, the intermediary transmits an appropriate confirmation to the exhibitors. The confirmation can contain an indication that the exhibitor has satisfied the requirements of the insurance registration process, such as submitting satisfactory proof of insurance, requesting insurance through the intermediary or having been automatically enrolled. The confirmation may be used as proof to the trade show owner and/or management that the exhibitor has insurance coverage for the trade show. The confirmation may be transmitted in any appropriate form, including, for example, electronic mail, file transfer, facsimile, mail or courier, and so forth.

In block 50, the intermediary transmits appropriate information to the trade show owner and/or management. In one embodiment, a list of those exhibitors that have satisfied the requirements of the insurance registration process is transmitted in block 50. The list, which may be in a database format, can distinguish between those exhibitors that submitted satisfactory proof of insurance, those exhibitors that requested insurance through the intermediary and those exhibitors that were automatically enrolled. In one embodiment, the list can identify any exhibitors that somehow did not fall into one of these three categories and requires special handling. In one embodiment, the list can identify any exhibitors who owe funds to the intermediary for insurance that was either requested in block 42 or automatically enrolled in block 46. Collection of those funds may be made at the commencement time 16 (FIG. 2) of the trade show, such as during a registration process. If funds are not supplied, in one embodiment, the exhibitor can be prevented from participating in the trade show.

It will be appreciated that some exhibitors may have circumstances that do not lend to interaction with the method 10. In those situations, the insurance needs of the exhibitor can be handled on a case by case basis to resolve any outstanding issues and complete the registration process. One special situation falling outside the above-described method 10 is for exhibitors for which the trade show owner and/or management has waived any insurance requirements that would normally be placed on exhibitors at the trade show. Waiving insurance requirements may be reserved for special exhibitors or important clients of the trade owner and/or management. When waiving the insurance requirements for an exhibitor, the trade show owner and /or management may request that the intermediary add the waived exhibitor to the insurance policy purchased in block 14. The cost of adding such an exhibitor can be borne by the trade show owner and/or management, and/or the intermediary.

As will be appreciated, disclosed is a method for offering insurance and providing insurance registration to trade show owners, management and exhibitors. In that method, the responsibility and effort involved with the insurance process for the trade show (or plural shows) is transferred from the trade show owner and/or management to the intermediary. As a result, resources of the trade show owner and/or management can be applied to other tasks instead of verifying that the exhibitors have the correct insurance coverage and answering insurance related questions of the exhibitors. In addition, it is contemplated that the intermediary will have some level of expertise with insurance matters. Accordingly, the intermediary can assist in arranging a suitable amount of insurance coverage for each of the parties based on the type of trade show. Also, if a claim should occur, the intermediary can assist the trade show owner and/or management, the exhibitors and, in some situations, the venue in addressing the claim. For example, many claims may be defended or paid by the insurance provider that sold the policy purchased in block 14 rather than other insurance policies that insure the various parties. Finding exhibitors after a claim has been filed has been an issue in the past, particularly for out-of-state exhibitors, out-of-country exhibitors or small exhibitors. The information collected by the intermediary during the insurance registration process may be beneficial for locating exhibitors in the event of claim.

The method not only has benefits to the trade show owner and/or management, the insurance validation and/or acquisition process for the exhibitors is simplified relative to convention approaches. As indicated, in some cases, acts to request insurance through the intermediary may be completed by the exhibitors in five minutes or less and may cost less than obtaining an individual policy. In addition, the exhibitors can get answers to insurance related questions from a single, typically knowledgeable, source.

Should a claim arise and plural exhibitors and, if appropriate, the trade show owner and/or management are named on the policy, the number of coverage issues can be reduced compared to a situation where some exhibitors do not have insurance or there are plural insurance providers involved. In addition, the venue can be given an assurance by the trade show owner and/or management that each exhibitor has at least a specified amount of insurance coverage in place.

With additional reference to FIG. 3, an exemplary embodiment of a system 52 for offering insurance and providing insurance registration to trade show owners, management and exhibitors is illustrated. The system 52 can include a host computing device 54. The host 54 can be a general purpose computing device, such as a network or “web” server, a desktop computer, a work-station, a portable computer (also referred to as a laptop computer), a personal digital assistant (PDA), and the like. Accordingly, the host can include a processor (or processors) 56 for executing instructions, usually in the form of computer code, to carry out a specified logic routine.

The host 54 can also have a memory (or multiple memory components) 58 for storing data, software, logic routine instructions, computer programs, files, operating system instructions, and the like. The memory 58 can comprise several devices and includes, for example, volatile and non-volatile memory components (e.g., random access memory (RAM), read-only memory (ROM), hard disks, floppy disks, compact disks (including, but not limited to, CD-ROM, DVD-ROM, CD-RW and DVD-RW), tapes, and/or other memory components, plus associated drives and players for these memory types).

The processor 56 and the memory 58 can be coupled via a local interface 60, such as a data bus with accompanying control bus, or a network between the processor(s) 56 and memory(ies) 58. In addition, the host 54 can have a number of external interfaces, each coupled to the local interface 60. The external interfaces, illustrated as video and I/O interfaces 62 can include, for example, a video interface, input interfaces and output interfaces. In addition, the host 54 can include one or more communications interfaces 64.

A display 66 can be coupled to the host 54 via an appropriate interface 70. Input devices (e.g., a keyboard 68, a mouse 70, a microphone, etc.) can be coupled to the host 54 via appropriate interfaces 62. Output devices (e.g., a printer 72, a speaker, etc.) can be coupled to the host 54 via appropriate interfaces 62.

The communications interface(s) 64 can include, for example, a modem, a network card and/or other type of transceiver. In the illustrated embodiment, the communications interface 64 is coupled to an external network 74 to enable the host 54 to send and receive data signals, voice signals, video signals, and the like via the external network 74, as is well known in the art. The external network 74 can include one or more networks, such as the Internet, a wide area network (WAN), a local area network (LAN), a direct data link, a telephone network or other similar network or communications link, including wired and wireless network arrangements.

The memory 58 can store an operating system 76 that is executed by the processor 56 to control the allocation and usage of resources in the host 54. Specifically, the operating system 76 controls the allocation and usage of the memory 58, the processing time of the processor 56 that is dedicated to various applications 78 being executed by the processor 56 and to the peripheral devices, as well as performing other functionality. In this manner, the operating system 76 serves as the foundation on which the applications 78 depend, as is generally known by those with ordinary skill in the art. The applications 78 can include a variety of “programs” that carry out a wide range of functionality, such as, a word processing program, a spreadsheet program, a personal organizer program, a graphical arts program, an image or photograph manipulation program, an Internet browser, an Internet webpage hosting program, a database management program, and so on.

The memory 58 can store and the processor 56 can execute, as part of one or more applications 78, a trade show insurance management function 80. For instance, the trade show insurance management function 80 can include an interactive webpage or set webpages that allow the trade show owner and/or management and the exhibitors to interact with the intermediary using a client computing device 82. The client computing device 82 can be any appropriate general purpose computing device, such as those described above for the host computing device 54. For example, the webpage(s) can allow the intermediary to submit questions or proof of insurance to the intermediary, or request insurance through the intermediary. The client computing device 82 can assist in generating and sending electronic mail messages and/or files to the trade show owner and/or management and the exhibitors, including the above-described notices to the exhibitioners, the list(s) transmitted in block 50 and so forth.

A database management component of the trade show insurance management function 80 can organize data relating to the exhibitors and prompt the user of the host 54 to carry out certain tasks. The database management component can automatically generate notices and lists upon the occurrence of a certain event or upon the reaching of a certain time and/or date. In addition, the database management component can generate an output to add or assist in adding exhibitioners to the insurance policy purchased in block 14. An insurance request component can take in exhibitioner data and handle credit (or debit) card transactions (e.g., interface with credit agencies appropriate for credit/debit card information submitted by the exhibitors). The insurance request component can interact with the database management component to automatically add and/or revised exhibitioner data. Other features, components and functions of the trade show insurance management function 80 to carry out all or portions of the method 10 will be apparent to those of ordinary skill in the art.

It will be apparent to a person having ordinary skill in the art of computer programming, and specifically in webpage hosting and database management, how to program the host 54 to operate and carry out the functions described herein. Accordingly, details as to the specific programming code have been left out for sake of brevity. Also, while the trade show insurance management function 80 is executed as part of one or more applications 78 by the processor 56 in accordance with an embodiment of the invention, such functionality could also be carried out via dedicated hardware, firmware, software, or combinations thereof, without departing from the scope of the invention. In addition, corresponding functions of a server and/or client computing devices 82 that interact with the host 54 can be embodied in any suitable form including executable logic that is stored by a memory of those devices and/or executed by a processor of those devices.

The figures show the architecture, functionality, and operation of an implementation of the method 10 and the trade show insurance management function 80. If embodied in software, each illustrated block may represent a module, segment, or portion of code that comprises program instructions to implement the specified logical function(s). The program instructions may be embodied in the form of source code that comprises human readable statements written in a programming language or machine code that comprises numerical instructions recognizable by a suitable execution system such as a processor in a computer system or other system. The machine code may be converted from the source code. If embodied in hardware, each block may represent a circuit or a number of interconnected circuits to implement the specified logical function(s).

Also, where the trade show insurance management function 80 comprises software or code, the trade show insurance management function 80 can be embodied in any computer useable or readable medium for use by or in connection with an instruction execution system such as, for example, a processor in a computer system or other system. In this sense, the logic may comprise, for example, statements including instructions or declarations that can be fetched from the computer-readable medium and executed by the instruction logic system. In the context of the present invention, a “computer-readable medium” can be any medium that can contain, store or maintain the logic described herein for use by or in connection with the instruction execution system. A computer-readable medium can comprise any one of many physical media such as, for example, electronic, magnetic, optical, electromagnetic, or semiconductor media. More specific examples of suitable computer-readable medium will include, but are not limited to, tapes, floppy disks, hard drives, or compact disks. Also, the computer-readable medium can be random access memory (RAM) including, for example, static random access memory (SRAM), dynamic random access memory (DRAM), and/or magnetic random access memory (MRAM). In addition, the computer-readable medium can be a read-only memory (ROM), a programmable read-only memory (PROM), an erasable programmable read-only memory (EPROM), an electronically erasable programmable read-only memory (EEPROM), and/or other type of memory device, including flash memory devices.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of providing insurance registration services to the owner or management of a trade show, comprising:
receiving a list of exhibitors for the trade show from the owner or management; and
offering to the exhibitors insurance coverage for the trade show.

2. The method of claim 1, further comprising arranging for an insurance policy for each exhibitor of the trade show.

3. The method of claim 2, wherein the arranging for the insurance policy includes contracting with an insurance agent or insurance provider to issue the insurance policy.

4. The method of claim 1, further comprising paying the owner or management for the list of exhibitors.

5. The method of claim 4, wherein the payment is based on the number of exhibitors.

6. The method of claim 1, further comprising receiving a request for insurance from at least one of the exhibitors.

7. The method of claim 6, further comprising adding the exhibitor that requested insurance to an insurance policy for the trade show.

8. The method of claim 6, wherein the request for insurance is received via the Internet by interaction of the exhibitor with a webpage.

9. The method of claim 6, further comprising approving an insurance status of the exhibitor for participation in the trade show.

10. The method of claim 1, further comprising offering to receive proof of insurance from the exhibitors.

11. The method of claim 10, further comprising approving an exhibitor for participation in the trade show upon receipt of satisfactory proof of insurance.

12. The method of claim 10, further comprising, for each exhibitor from which no request for insurance or proof of insurance is received by a predetermined deadline, adding the exhibitor to an insurance policy.

13. The method of claim 12, wherein the insurance policy names each exhibitor as an insured party.

14. The method of claim 12, further comprising charging a fee to exhibitors that at least one of request insurance or were added to the insurance policy.

15. A method of providing insurance registration services to the owner or management of a trade show at which exhibitors are scheduled to participate, comprising:
arranging for an insurance policy for the trade show; and
approving each exhibitor for participation in the trade show following receipt of one of a request for insurance or satisfactory proof of insurance from the exhibitor.

16. The method of claim 15, wherein the insurance policy names all exhibitors as insureds.

17. The method of claim 15, further comprising upon receipt of a request for insurance, adding the corresponding exhibitor to the insurance policy.

18. The method of claim 17, wherein the request for insurance is received via the Internet by interaction of the exhibitor with a webpage.

19. The method of claim 15, further comprising, for each exhibitor from which no request for insurance or proof of insurance is received by a predetermined deadline, adding the exhibitor to the insurance policy.

20. The method of claim 19, further comprising invoicing each exhibitor added to the insurance policy.
